(19) United States
(12) Patent Application Publication
(10) Pub. No.: US 2007/0276058 A1
(43) Pub. Date: Nov. 29, 2007

(54) Polyurethane composition

(75) Inventors: Urs Burckhardt, Zurich (CH); Ursula Stadelmann, Zurich (CH)

Correspondence Address: OLIFF & BERRIDGE, PLC, P.O. BOX 19928, ALEXANDRIA, VA, 22320, US

(73) Assignee: SIKA SCHWEIZ AG, Zurich (CH)

(21) Appl. No.: 11/822,111

(22) Filed: Jul. 2, 2007

Related U.S. Application Data
(63) Continuation of application No. 10/501,078, filed on Jul. 9, 2004, now abandoned.

(30) Foreign Application Priority Data
Jan. 18, 2002 (EP) 02001289.04

(51) Int. Cl. C08G 18/00

(52) U.S. Cl. 522/90

(57) ABSTRACT

A composition comprising at least one polyurethane prepolymer A having isocyanate end groups, prepared from at least one polyisocyanate with at least one polyol A1 and optionally at least one polyol A2, wherein A1 linear polyoxyalkylene polyol having a degree of unsaturation <0.04 meq/g; A2 is polyol in an amount of 0-30% by weight, based on the total amount of A1+A2; and at least one polyaldimine.

### TECHNICAL FIELD

The invention relates to compositions comprising specific high molecular weight polyurethane prepolymers prepared starting from specific predominantly linear long-chain polyoxyalkylene polyols with a low degree of unsaturation and polyaldimines.

### PRIOR ART

Polyurethanes are used as, among other things, one-component, moisture-curing, elastic sealants, adhesives and coatings. Usually they comprise a polyurethane prepolymer, prepared from polyols and polyisocyanates in a stoichiometric excess, which is subsequently combined with further components and stored in the absence of moisture until its use. These conventional systems have a number of disadvantages. The reaction of the isocyanate groups, as a result of the reaction with water, from the air for example (atmospheric humidity), produces a certain amount of CO₂ gas, depending on the isocyanate content of the mixture. Depending on formulation and application conditions, the CO₂ gas formed can lead to bubbles in the cured product. This unwanted formation of bubbles is promoted by a number of factors, specifically a high level of isocyanate groups in the composition, a relatively low viscosity, a rapid curing rate, and a porous substrate. A further disadvantage is the relatively narrow limitation of the mechanical strengths which are achieved with such one-component compositions after their curing. On the one hand the mechanical strengths which are achievable with a particular prepolymer per se are limited. For a marked alteration of the mechanical values upward or downward it is necessary in each case to use a separate prepolymer formulated specifically for those desired mechanical properties. On the other hand, in the formulation of compositions having maximum strengths, there is an additional limitation owing to the bubbles problem and high viscosities. The prepolymers required to achieve high strengths either have very high viscosities, as a result of high functionality (markedly higher than 2) or as a result of preliminary chain linkage on the part of relatively short-chain diols, by means of diisocyanates, to form longer-chain (and the resultant high concentrations of urethane groups), these very high viscosities severely hampering their processing, or they contain high fractions of free isocyanate groups, as a result of which they have a very strong tendency to form bubbles on curing, or a combination of both. Very high tensile strengths, in the region of 10 MPa or more for example, are therefore virtually impossible to achieve in a manner suitable for practice with one-component moisture-curing polyurethanes with the present state of the art.

A further disadvantage exists in connection with the use of polyurethanes as flexible construction sealants, which are used for sealing joints in the construction industry. A sealant of this kind must on the one hand have a very low elasticity modulus and at the same time high elongation and good resilience. Such products according to the state of the art normally have a very tacky surface, which tends toward unattractive soiling.

As an alternative there are two-component systems, but they have the known disadvantage of the mixing operation, which represents not only additional effort for the user but also a source of error which is not to be underestimated in connection with the application of the product.

Polyols usually used for preparing polyurethane prepolymers for very flexible compositions are polyoxyalkylene polyols, principally polypropylene glycols. Usually these polyols are prepared by base catalysis. The base-catalyzed polymerization process results, however, in polyols having a relatively high fraction of mono-hydroxy-functional molecules, referred to as monools, which carry a double bond at one chain end. As the molecular weight of the polyol increases, there is a sharp rise in the monool content and hence in the degree of unsaturation. When linear polyols are used a low OH functionality (i.e., markedly below the ideal value of 2), in other words a high degree of unsaturation, leads to poor mechanical properties in the cured state. On the basis of polyols prepared by base catalysis, therefore, the achievement of high molecular weights in polyurethane prepolymers is possible only as a result of the joining of relatively short-chain diols by means of polyisocyanates, leading to prepolymers having undesiredly high viscosities.

Special polyoxyalkylene polyols having a high molecular weight and a very low degree of unsaturation, prepared by means of what are called double metal cyanide complex catalysts, DMC catalysts for short, were developed in the 1960s and described in U.S. Pat. No. 3,427,256, U.S. Pat. No. 3,427,334, U.S. Pat. No. 3,427,335, U.S. Pat. No. 3,829,505 and U.S. Pat. No. 3,941,849. These polyols have a very low degree of unsaturation and also an OH functionality of only a little less than 2.

Since that time the technology of DMC catalysis has been continually improved and corresponding products have been commercialized. Patents WO 99/29752, U.S. Pat. No. 5,849,944 and U.S. Pat. No. 6,036,879, for example, describe applications of such polyols as two-component casting elastomers.

It is possible by using these specific polyols in one-component, moisture-curing, elastic sealants and adhesives to prepare high molecular weight polyurethane prepolymers having a low viscosity. However, there are other difficulties which it has not proved possible to solve to satisfaction to date. Thus high molecular weight prepolymers, synthesized on the basis of the high molecular weight polyols mentioned, are indeed low in viscosity in comparison to corresponding high molecular weight prepolymers in which relatively short-chain polyols have been joined to diisocyanates to form longer chains; however, they are also substantially more hydrophobic, owing to the lower concentration of urethane groups. A result of this is that these more hydrophobic prepolymers cure much more slowly with moisture, since the water is available only in a small amount, and, on the other hand, that the susceptibility to bubble formation is higher, owing to the CO₂ gas which is given off in the course of curing with moisture, since said gas is dissolved much less effectively by the more hydrophobic polymer. An adhesive suitable for industrial applications is required, however, to cure rapidly, and to do so generally with only a small free surface area available for absorbing the required water from the air. In order to achieve the high mechanical strengths which are often required, moreover, there is a need for a high isocyanate content. This produces a relatively large amount of CO₂ on curing, which, as already described, leads to the problem of bubble formation in the course of curing.

U.S. Pat. No. 5,124,425 describes the use of such polyols, prepared by means of DMC catalysis, among other things as one-component moisture-curing or two-component polyurethanes. In the examples tensile strengths up to 1.7 MPa are attained. Strengths much higher than this cannot be achieved in the method described, since the problem of bubble formation with relatively high isocyanate group contents has not been solved.

In order to avoid the formation of bubbles in one-component polyurethane sealants and adhesives there are a variety of possibilities. On the one hand some or all of the isocyanate end groups of the prepolymer can be converted to alkoxysilane end groups by reacting them with, for example, an aminoalkyl-alkoxysilane. This produces an alkoxysilane-terminal prepolymer, which likewise cures by contact with moisture via hydrolysis of the alkoxysilane groups and subsequent condensation of the silanol groups to form siloxane moieties. This curing mechanism does not form CO₂, and accordingly there are fewer bubbles formed, or none. Crosslinking via alkoxysilane groups does, however, lead to products having a low breaking elongation and low strengths. EP 1 093 482 describes polyurethanes based on polyols of high molecular weight, with a narrow molar weight distribution and an OH functionality in the vicinity of 2. In order to avoid bubbles it is possible for some or all of the isocyanate end groups of the prepolymer to be reacted with organosilanes such as aminoalkyl-alkoxysilanes, for example. As already mentioned, it is not possible in this way to formulate polyurethanes having high elongations and strengths. Accordingly the sole example of that patent, a system which cures predominantly by way of alkoxysilanes, has a tensile strength of only 0.49 MPa with a breaking elongation of 276%.

Polyaldimines are compounds which are known in polyurethane chemistry, described for example in U.S. Pat. No. 3,420,800 and U.S. Pat. No. 3,567,692. From polyurethane prepolymers containing isocyanate groups and from polyaldimines it is possible to formulate one-component products. On contact with moisture the polyaldimines hydrolyze to form the corresponding aldehydes and polyamines, whereupon the latter react with the isocyanate groups of the prepolymer and hence cure it without release of CO₂. Systems of this kind have been described for example in U.S. Pat. No. 3,932,357, U.S. Pat. No. 4,009,307, U.S. Pat. No. 4,720,535, U.S. Pat. No. 4,853,454, U.S. Pat. No. 5,087,661 and EP 985 693.

### DESCRIPTION OF THE INVENTION

It was an object of the present invention to provide compositions which, starting from only one or a few high molecular weight polyurethane prepolymers, cover a large spectrum of mechanical strengths, and which have additional advantages over the prior art. Thus on the one hand the desire is for products which combine a low elasticity modulus, high elongation and good resilience with a very dry surface and are therefore suitable as construction sealants for the sealing of joints; on the other hand there is a need for highly flexible products which cure quickly and without bubbles, have high to very high mechanical strengths and are therefore suitable as adhesives for all kinds of industrial applications. These compositions ought at the same time to have a very low processing viscosity, thereby allowing the formulation of products which can be applied with relatively little force applied, which exhibit short string rupture on application (so that the surroundings are not soiled with the product when the application tip is placed down and drawn away), and contain a small amount or none at all of solvents and plasticizers, which is advantageous not only for the adhesion properties of the product but also from environmental standpoints, since not only the solvents (VOCs=volatile organic compounds) but also the plasticizers, generally phthalate compounds, are not unproblematic for the environment. Furthermore, any plasticizers present tend to migrate from the composition when applied to porous substrates such as natural stone slabs and when overcoated with paints. As a result it is possible, for example, for unattractive discolorations of the substrate to appear alongside a joint, or a coating becomes soft and tacky.

Surprisingly it has been found that these problems can be solved through the combination of specific, linear polyurethane prepolymers A of high molecular weight, prepared starting from specific, predominantly long-chain polyoxyalkylene polyols having a low degree of unsaturation, with polyaldimines B.

With the combination described here of specific, high molecular weight polyurethane prepolymer prepared starting from specific linear, long-chain polyoxyalkylene polyols with a low degree of unsaturation and polyaldimines it is possible, by varying and combining different polyaldimines with only a few prepolymers, to formulate different highly flexible products having a very broad spectrum of mechanical strength (tensile strength, for example, in the range from approximately 1 to more than 20 MPa) and having breaking elongations of up to more than 1000%, these products being stable on storage in appropriate packaging in the absence of moisture, having a low processing viscosity, curing rapidly and without bubbles on contact with moisture, and having a very dry surface in the cured state.

Using compositions of this kind it is possible to achieve significant reductions in the number of prepolymers required in a production operation for the formulation of different polyurethane sealants, adhesives and coatings which satisfy extremely different requirements in respect of the profile of mechanical properties. Since the handling and the storage of different prepolymers, with their high viscosity, their sensitivity to moisture and the space they occupy, is associated with high cost and inconvenience for an industrial production operation, the reduction in the number of required prepolymers for preparing different products is of great advantage and constitutes progress in the technology. Moreover, using such compositions it is possible, with a minimum set of prepolymers, to formulate not only flexible construction sealants featuring high elongation and good resilience and a very dry surface but also to prepare high-strength elastic adhesives having tensile strengths of up to 20 MPa or more which cure rapidly and without bubbles. The consistently low viscosity of such compositions makes it possible, furthermore, to prepare low-solvent and low-plasticizer or solvent-free and plasticizer-free products which have good processing properties, which is an advantage in respect of their adhesion properties, their migration stability and from environmental standpoints.

An additional advantage over the prior art is that the cured compositions described are more hydrophobic than those based on conventional polyols. Consequently they exhibit less unwanted water absorption, hence in turn less swelling and a lower sensitivity to hydrolysis.

Furthermore it is possible in accordance with one preferred embodiment of compositions to dispense entirely with the use of organometallic catalysts, especially tin catalysts. This results in higher thermal stabilities of the cured material as a result of slower reformation of urethane; and additionally this is an environmental advantage, in view of the potential toxicity and environmental hazard posed by the metals, particularly the organotin compounds.

The present invention relates to compositions which comprise at least one polyurethane prepolymer A having isocyanate end groups and at least one polyaldimine B, the polyurethane prepolymer A being prepared from at least one polyol A1 and if desired at least one polyol A2 and also polyisocyanates. The polyol A1 is a linear polyoxyalkylene polyol and has a degree of unsaturation of <0.04 meq/g while the polyol A2 is present in an amount of 0-30% by weight, preferably 0-20% by weight, in particular 0-10% by weight, based on the total amount of A1+A2. In addition to the components mentioned a composition can according to one preferred embodiment further comprise one or more of the following components: plasticizers, solvents, fillers, pigments, catalysts, rheology modifiers such as thickeners, for example, adhesion promoters, driers, antioxidants, light stabilizers and other additives customary in the polyurethane industry.

Described in addition is the use of this composition as an adhesive, sealant, coating or covering. Further provided are processes for preparing the composition and also processes for bonding, sealing or coating. Described finally are articles whose surface has been contacted at least partly with such a composition.

Way of Implementing the Invention

The present invention relates to compositions which comprise at least one polyurethane prepolymer A having isocyanate end groups and at least one polyaldimine B, the polyurethane prepolymer A being prepared from at least one polyol A1 and if desired at least one polyol A2 and also polyisocyanates. The polyol A1 is a linear polyoxyalkylene polyol and has a degree of unsaturation of <0.04 meq/g while the polyol A2 is present in an amount of 0-30% by weight, preferably 0-20% by weight, in particular 0-10% by weight, based on the total amount of A1+A2.

The polyurethane prepolymer A is prepared by reacting the polyol with a polyisocyanate, the polyol being composed of at least 70% by weight, preferably at least 80% by weight, of at least one linear polyol A1. This reaction can take place by reacting the polyol and the polyisocyanate by customary processes, at temperatures of from 50 to 100° C. for example, with or without the use of suitable catalysts, the polyisocyanate being used in a stoichiometric excess. The reaction product formed is the polyurethane prepolymer A having isocyanate end groups.

The polyol A1 is a linear polyoxyalkylene polyol having a total degree of unsaturation of <0.04 meq/g, preferably <0.02 meq/g and more preferably <0.017 meq/g. In one preferred embodiment the polyol A1 has a molecular weight of from 2000 to 30 000 g/mol.

These linear polyoxyalkylene polyols are reaction products of a difunctional starter molecule in the form of a short diol with alkylene oxides such as 1,2-propylene oxide or ethylene oxide, it being possible to use the alkylene oxides individually, alternately in succession or as mixtures. The polymerization catalyst used is normally what is called a double metal cyanide complex, DMC catalyst for short.

Polyols of this kind are available commercially for example under the names Acclaim® and Arcol® from Bayer, Preminol® from Asahi Glass, Alcupol® from Repsol and Poly-L® from Arch Chemicals. As a result of the use of a DMC catalyst during their preparation they have a very low degree of unsaturation. This means that the amount in these polyols of polyoxypropylenes which carry as end groups a double bond at one chain end and an OH group at the other chain end (“monools”) is very low. Monools come about as a result of isomerization of propylene oxide to allyl alcohol during the propoxylation, leading to the formation of allyl-terminated polyoxypropylenes. The degree of unsaturation is measured in accordance with ASTM D-2849-69, “testing urethane foam polyol raw materials”, and reported as milliequivalents of unsaturation per gram of polyol (meq/g). The total degree of unsaturation (meq/g) of these polyols corresponds to the monool content. From the average molecular weight (or alternatively with the total OH content) and the total degree of unsaturation it is possible to calculate the average OH functionality of the polyol. Preferred polyols are pure polyoxypropylene diols and also “EO-endcapped” (ethylene oxide-encapped) polyoxypropylene diols. The latter are special polyoxypropylene-polyoxyethylene diols which are obtained by alkoxylating pure polyoxypropylene diols with ethylene oxide after the end of the polypropoxylation, and which therefore contain primary hydroxyl groups. Mixtures of said polyols can also be used.

The remaining 0 to 30% by weight of the polyol is accounted for by the polyols A2 below, which are very well known in polyurethane chemistry and are not of the same type as the polyol A1:
polyoxyalkylene polyols having a total degree of unsaturation of more than 0.04 meq/g and/or a low molecular weight and/or an OH functionality of greater than 2, particularly those having a total degree of unsaturation <0.1 meq/g and/or a molecular weight of from 400 to 2000 and/or those having an OH functionality of more than 2 and up to about 3, which are products of the polyalkoxylation of a starter molecule with ethylene oxide, 1,2-propylene oxide, 1,2- and 2,3-butylene oxide, tetrahydrofuran or mixtures thereof;
polyhydroxy-terminated polybutadiene polyols;
polyester polyols, prepared for example from dihydric to trihydric alcohols such as 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the aforementioned alcohols with organic dicarboxylic acids or their anhydrides or esters such as succinic acid, glutaric acid, adipic acid, suberic acid, sebacic acid, decanedicarboxylic acid, maleic acid, fumaric acid, phthalic acid, isophthalic acid, terephthalic acid and hexahydrophthalic acid or mixtures of the aforementioned acids, for example, and also polyester polyols formed from lactones, ε-caprolactone for example;
polycarbonate polyols, such as are obtainable by reacting, for example, the abovementioned alcohols—those used to synthesize the polyester polyols—with dialkyl carbonates, diaryl carbonates or phosgene;
additionally, low molecular weight, hydroxyl-containing compounds such as 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, hydrogenated bisphenol A, 1,1,1-trimethylolethane, 1,1,1-trimethylolpropane and glycerol, for example,
and also mixtures of the aforementioned hydroxyl-containing compounds.

To prepare the polyurethane prepolymer, polyisocyanates are used. Preferred polyisocyanates are diisocyanates. Examples that may be mentioned include the following isocyanates, which are very well known in polyurethane chemistry:

2,4- and 2,6-tolylene diisocyanate (TDI) and any mixtures of these isomers, 4,4′-diphenylmethane diisocyanate (MDI), the positionally isomeric diphenylmethane diisocyanates and also oligomers and polymers of these isocyanates, 1,3- and 1,4-phenylene diisocyanate, 1,6-hexamethylene diisocyanate, 2,2,4- and 2,4,4-trimethyl-1,6-hexamethylene diisocyanate, 1,12-dodecamethylene diisocyanate, cyclohexane 1,3- and 1,4-diisocyanate and any desired mixtures of these isomers, 1-isocyanato-3,3,5-trimethyl-5-isocyanato-methylcyclohexane (=isophorone diisocyanate or IPDI), perhydro-2,4′- and -4,4′-diphenylmethane diisocyanate, 1,3- and 1,4-tetramethylxylylene diisocyanate, and any desired mixtures of the aforementioned isocyanates.

The polyaldimines B are prepared on the basis of polyamines and aldehydes by means of a condensation reaction with elimination of water. Such condensation reactions are very well known and are described, for example, in Houben-Weyl, “Methoden der organischen Chemie”, Vol. XI/2, page 73 ff. Equivalent amounts of aldehyde groups R¹—CH═O are reacted with primary amino groups R²—NH₂ to form aldimine moieties R¹—CH═N—R². R¹ and R² are for example an aliphatic, cycloaliphatic or aromatic radical which may contain, for example, ester moieties, carboxylic acid moieties, ether moieties and heteroatoms and also further imino groups. R¹ and R² are, for example, the radicals of the polyamines (R²) or aldehydes (R¹), respectively, recited later on below.

As polyaldimine B it is also possible to use mixtures of different polyaldimines, especially mixtures of different polyaldimines prepared by means of different polyamines, reacted with different or the same aldehydes, including in particular polyaldimines prepared by means of polyamines having different amino functionalities.

Suitable polyamines include polyamines which are very well known in polyurethane chemistry, such as are used, among other things, for two-component polyurethanes. Examples that may be mentioned include the following:

aliphatic polyamines such as ethylenediamine, 1,2- and 1,3-propanediamine, 2-methyl-1,2-propanediamine, 2,2-dimethyl-1,3-propanediamine, 1,3- and 1,4-butanediamine, 1,3- and 1,5-pentanediamine, 1,6-hexanediamine, 2,2,4- and 2,4,4-trimethylhexamethylenediamine and mixtures thereof, 1,7-heptanediamine, 1,8-octanediamine, 4-aminomethyl-1,8-octanediamine, 1,9-nonanediamine, 1,10-decanediamine, 1,11-undecanediamine, 1,12-dodecanediamine, methylbis(3-aminopropyl)amine, 1,5-diamino-2-methylpentane, 1,3-diaminopentane (DAMP), 2,5-dimethyl-1,6-hexamethylenediamine, cycloaliphatic polyamines such as 1,3- and 1,4-diaminocyclohexane, bis(4-aminocyclohexyl)methane, bis(4-amino-3-methylcyclohexyl)methane, bis(4-amino-3-ethylcyclohexyl)methane, bis(4-amino-3,5-dimethylcyclohexyl)methane, 1-amino-3-aminomethyl-3,5,5-trimethylcyclohexane (=isophoronediamine or IPDA), 2- and 4-methyl-1,3-diaminocyclohexane and mixtures thereof, 1,3- and 1,4-bis(aminomethyl)cyclohexane, 1-cyclohexylamino-3-aminopropane, 2,5(2,6)-bis(aminomethyl)bicyclo-[2.2.1]heptane (NBDA, prepared by Mitsui Chemicals), 3(4),8(9)-bis(aminomethyl)tricyclo[5.2.1.0^{2,6}]decane (TCD-Diamin®, prepared by Celanese Chemicals), 3,9-bis-(3-aminopropyl)-2,4,8,10-tetraoxaspiro[5,5]undecane, 1,3- and 1,4-xylylenediamine, aliphatic polyamines containing ether groups, such as bis(2-aminoethyl)ether, 4,7-dioxadecane-1,10-diamine, 4,9-dioxadodecane-1,12-diamine and higher oligomers thereof, polyoxyalkylene-polyamines having an amino functionality of 2 or 3 theoretically, obtainable under the name Jeffamine®, prepared by Huntsman Chemicals, and also mixtures of the aforementioned polyamines.

Preferred polyamines are 1,6-hexamethylenediamine, 1,5-diamino-2-methylpentane, DAMP, IPDA, 4-aminomethyl-1,8-octanediamine, 1,3-xylylenediamine, 1,3-bis-(aminomethyl)cyclohexane, bis(4-aminocyclohexyl)methane, bis(4-amino-3-methylcyclohexyl)methane, TCD-Diamin®, the Jeffamine® grades Jeffamine® EDR-148, Jeffamine® D-230, Jeffamine® D-400 and Jeffamine® T-403, and in particular mixtures of two or more of the aforementioned polyamines.

Suitable aldehydes for the condensation reaction with the polyamines include for example the following:

aliphatic or cycloaliphatic aldehydes such as propanal, pivalaldehyde (=trimethylacetaldehyde), isobutyraldehyde, hexanal, 2-ethylhexanal, 2-methylbutanal, 2-ethylbutanal, octylaldehyde, valeraldehyde, isovaleraldehyde, 2-methylvaleraldehyde, 2,3-dimethylvaleraldehyde, 2-methylundecanal, cyclohexylcarboxaldehyde, methoxyacetaldehyde, 2-alkoxy-2-methylpropanals such as 2-methoxy-2-methylpropanal, for example, esters of organic carboxylic acids and 2-hydroxy-2-methylpropanal, such as 2-acetoxyisobutyraldehyde, for example, 3-alkoxy-2,2-dimethylpropanals such as 3-n-butoxy-2,2-dimethylpropanal, for example, esters of 2,2-dimethyl-3-hydroxypropanal and short-chain organic carboxylic acids, such as 2,2-dimethyl-3-acetyloxypropanal and 2,2-dimethyl-3-isobutyroxypropanal, for example, cyclopropanecarboxaldehyde, 9-ethyl-3-carbazolecarboxaldehyde, 10-methylanthracene-9-carboxaldehyde, pyrenecarboxaldehyde, benzaldehyde, o-, m- and p-tolylaldehyde, 2- and 4-methylbenzaldehyde, 2- and 4-ethylbenzaldehyde, 2- and 4-propylbenzaldehyde, 2- and 4-butylbenzaldehyde, 2,4-dimethylbenzaldehyde, 2,4,5-trimethylbenzaldehyde, p-anisaldehyde, 3-methyl-p-anisaldehyde, m- and p-ethoxybenzaldehyde, m- and p-phenoxybenzaldehyde, nicotinaldehyde, terephthaldehyde, isophthaldehyde and diphenylacetaldehyde, and also mixtures of the aforementioned aldehydes.

For use with the highly reactive aromatic isocyanates such as TDI and MDI, for example, preference is given to those aldehydes which are unable to form tautomeric enols. With polyaldimines starting from such non-tautomerizing aldehydes it is possible with prepolymers starting from aromatic polyisocyanates to formulate compositions which are particularly stable on storage. Aldehydes which are unable to form tautomeric enols are those which do not contain a C—H moiety positioned a to the carbonyl group. This applies to aromatic aldehydes and also to aliphatic aldehydes having a tertiary carbon atom positioned a to the carbonyl group.

Particularly preferred aldehydes are benzaldehyde, m-phenoxybenzaldehyde, isophthalaldehyde, terephthalaldehyde; additionally pivalaldehyde and also esters of 2,2-dimethyl-3-hydroxypropanal and short-chain organic carboxylic acids, such as 2,2-dimethyl-3-acetyloxypropanal and 2,2-dimethyl-3-isobutyroxypropanal, for example.

The polyurethane prepolymer A and the polyaldimine B are mixed with one another, the polyaldimine B being metered in an amount from 0.1 to 1.1 equivalents of aldimine moieties per equivalent of isocyanate groups of the prepolymer A. Additionally it is possible to add a catalyst for the hydrolysis of the polyaldimine, an example being an organic carboxylic acid such as benzoic acid or salicylic acid, an organic carboxylic anhydride such as phthalic anhydride or hexahydrophthalic anhydride, a silyl ester of organic carboxylic acids, an organic sulfonic acid such as p-toluenesulfonic acid, or another organic or inorganic acid, or mixtures of the aforementioned acids.

By varying the polyaldimine B in combination with a polyurethane prepolymer A it is possible to formulate products having very different mechanical properties. Polyaldimines which lead to products having particular flexibility properties are for example those based on Jeffamine® grades or 1,5-diamino-2-methylpentane. Polyaldimines leading to products having particularly high strengths are for example those based on 1,6-hexamethylenediamine or 1,3-xylylenediamine, optionally in admixture with amines of higher functionality, such as 4-aminomethyl-1,8-octanediamine or Jeffamine® T-403, for example. Through the correct selection of the polyaldimine B, optionally in the form of a mixture of different polyaldimines, in combination with the polyurethane prepolymers A described it is possible to adjust the mechanical properties in the cured state of the high molecular weight compositions in accordance with what is desired: for example, to breaking elongations up to more than 1000% and tensile strengths from approximately 1 MPa to 20 MPa.

As a result of the possibility of varying the polyaldimine B and of the use of the specific high molecular weight polyurethane prepolymers A it is possible to reduce significantly the number of prepolymers required in a production operation for formulating different polyurethane sealants, adhesives and coatings, and also coverings, especially floor coverings, which meet very different requirements in respect of the profile of mechanical properties. Since the handling and the storage of different prepolymers is associated with great cost and inconvenience for an industrial production operation, in view of their viscosity, their sensitivity to moisture and the space they occupy, reducing the number of prepolymers required for preparing different products is advantageous. Moreover it is possible with such compositions to formulate not only flexible construction sealants having a very dry surface but also high-strength elastic adhesives having tensile strengths of up to 20 MPa or more, which have a low processing viscosity and cure rapidly and without bubbles.

Additional components that may be present in the compositions described include, among others, the following components well known in the polyurethane industry:

plasticizers, examples being esters of organic carboxylic acids or their anhydrides, phthalates, such as dioctyl phthalate or diisodecyl phthalate, adipates, such as dioctyl adipate, organic sulfonic esters, polybutenes and other compounds which do not react with isocyanates; solvents, organic and inorganic fillers, such as calcium carbonates, alternatively precipitated calcium carbonates uncoated or coated with stearates, or carbon blacks, kaolins, aluminas, silicas, PVC powders, fibers, of polyethylene for example, pigments, catalysts for the hydrolysis of the polyaldimine, organic carboxylic acids, such as benzoic acid and salicyclic acid, organic carboxylic anhydrides, such as phthalic anhydride and hexahydrophthalic anhydride, silyl esters of organic carboxylic acids, organic sulfonic acids such as p-toluenesulfonic acid, or other organic or inorganic acids, further catalysts, examples being organotin compounds such as dibutyltin dilaurate, dibutyltin acetylacetonate or other catalysts customary in polyurethane chemistry for the reaction of isocyanate groups; rheology modifiers, such as thickeners, examples being urea compounds, polyamide waxes, bentonites or pyrogenic silicas, adhesion promoters, examples being epoxysilanes, vinylsilanes, isocyanatosilanes and aminosilanes reacted with aldehydes to form aldiminosilanes, driers, such as p-tosyl isocyanate and other reactive isocyanates, orthoformic esters, calcium oxide or molecular sieves, stabilizers against heat, light and UV radiation, flame retardants, surface-active substances, substances having a fungistatic action, and further substances commonly used in the polyurethane industry.

The composition described is prepared and stored in the absence of moisture. Such compositions are stable on storage: that is, they can be kept in suitable packaging or in a suitable arrangement, such as in a drum, a pouch or a cartridge, for example, for a period ranging from several months up to a year or longer, prior to their use. On application the polyurethane composition comes into contact with moisture, whereupon the polyaldimines are hydrolyzed to aldehydes and polyamines and the polyamines react with the polyurethane prepolymer containing isocyanate groups. Either the water required for the reaction can come from the air (atmospheric humidity) or the composition can be contacted with a water-containing component, by being coated, for example, with a smoothing agent for example, by spraying or by means of immersion methods, or the composition can be admixed with a water-containing component, in the form for example of a hydrous paste, which can be metered in via a static mixer, for example.

If a deficit amount of the polyaldimine is used, in other words if the chosen ratio of aldimine groups to isocyanate groups is substoichiometric, then the excess isocyanate groups react with the water present. As a consequence of the reactions described above the composition cures.

The compositions described are suitable as sealants of all kinds, for the purpose for example of sealing joints in construction, as adhesives for the bonding of various substrates, such as for bonding components in the production of automobiles, rail vehicles or other industrial products, and as coatings or coverings for various articles and/or variable substrates. The composition is at least partly contacted with the surface of any desired substrate. Preferably a uniform contacting in the form of a sealant or adhesive, a coating or a covering is desired, and particularly in the areas which for the purpose of use require a bond in the form of an adhesive bond or seal or else whose substrate is to be covered over. It may well be necessary for the substrate, or the article in the foreground of contacting, to have to be subjected to a physical and/or chemical pretreatment, by abrading, sandblasting, brushing or the like, for example, or by treatment with cleaners, solvents, adhesion promoters, adhesion promoter solutions or primers, or the application of a tie coat or a sealer.

### EXAMPLES

“pbw” stands for parts by weight. All percentages are by weight where not stated otherwise. By the “total functionality prepolymer” is meant the average isocyanate functionality of the prepolymer used. By the “total functionality polyaldimines” is meant the average aldimine functionality of the polyaldimines used. Compositions which contain no polyaldimine (comparative examples) were cured exclusively with atmospheric moisture.

Polyols Used:

Arcol® PPG 2000 N (Bayer): linear polypropylene oxide polyol having a theoretical OH functionality of 2, an average molecular weight of about 2000, an OH number of about 56 mg KOH/g, and a degree of unsaturation of about 0.01 meq/g.

Acclaim® 4200 N (Bayer): linear polypropylene oxide polyol having a theoretical OH functionality of 2, an average molecular weight of about 4000, an OH number of about 28 mg KOH/g, and a degree of unsaturation of about 0.005 meq/g.

Acclaim® 12200 (Bayer): linear polypropylene oxide polyol having a theoretical OH functionality of 2, an average molecular weight of about 12 000, an OH number of about 11 mg KOH/g, and a degree of unsaturation of about 0.005 meq/g.

Caradol® ED 56-11 (Shell): linear polypropylene oxide polyol having a theoretical OH functionality of 2, an average molecular weight of about 2000, an OH number of about 56 mg KOH/g, and a degree of unsaturation of about 0.05 meq/g.

Voranol® EP 1900 (Dow): linear polypropylene oxide polyethylene oxide polyol, ethylene oxide-terminated, having a theoretical OH functionality of 2, an average molecular weight of about 4000, an OH number of about 29 mg KOH/g, and a degree of unsaturation of about 0.08 meq/g.

Caradol® MD34-02 (Shell): nonlinear polypropylene oxide polyethylene oxide polyol, ethylene oxide-terminated, having a theoretical OH functionality of 3, an average molecular weight of about 4900, an OH number of about 35 mg KOH/g, and a degree of unsaturation of about 0.08 meq/g.

Description of the Test Methods:

The viscosity was measured at 23° C. on a cone-and-plate viscometer from Haake (PK100/VT-500).

The skinning time (time to freedom from tack, “tack-free time”) was determined at 23° C. and 50% relative humidity.

Tensile strength, breaking elongation and elasticity modulus at 0.5-5% elongation were determined on films cured for 7 days at 23° C. and 50% relative humidity in accordance with DIN EN 53504 (traction speed: 200 mm/min).

Formation of bubbles was assessed qualitatively on the basis of the quantity of bubbles which appeared in the course of curing (at 23° C. and 50% relative humidity) of the films used for the mechanical tests (film thickness: 2 mm).

The expression force was determined on aluminum cartridges having a diameter of 45 mm, the sealant being pressed at the tip of the cartridge through an opening of 3 mm. Expression was carried out by a tensile testing machine at a speed of 60 mm/min.

String rupture was determined by causing a cylindrical penetration element with a diameter of 2 cm to penetrate to a depth of 0.5 cm into the sealant (film thickness: 1 cm, temperature: 20° C.) and extracting it again after about 1 second at constant speed (25 cm in 4 seconds). The length of the string of sealant remaining on the penetration element, defined as string rupture, was measured with a ruler to an accuracy of 1 mm. The procedure was repeated three times and the mean value of the measurements was determined as the result.

The surface of the cured sealant was assessed for tack by gentle contact with the finger.

The rate of cure through volume was determined at 23° C. and 50% relative humidity on a PTFE substrate.

The stress at 100% elongation was tested in accordance with DIN EN 28340, method A.

Preparation of Aldimines and Prepolymers

Polyaldimine A1

A round-bottomed flask was charged with 100 pbw of Jeffamine® D-230 (Huntsman Chemicals). With effective cooling and vigorous stirring, 91 pbw of benzaldehyde were added dropwise. Following the addition the mixture was stirred at room temperature for a further 10 minutes and then all of the water was removed by distillation under a water jet vacuum. The liquid reaction product obtained in this way had an aldimine content, determined as the amine content, of 4.65 mmol NH₂/g and was used further without purification.

Polyaldimine A2

A round-bottomed flask was charged with 25 pbw of TCD-Diamin® (Celanese Chemicals). With effective cooling and vigorous stirring, 41 pbw of 2,2-dimethyl-3-acetyloxypropanal were added dropwise. Following the addition the mixture was stirred at room temperature for a further 10 minutes and then all of the water was removed by distillation under a water jet vacuum. The liquid reaction product obtained in this way had an aldimine content, determined as the amine content, of 4.22 mmol NH₂/g and was used further without purification.

Polyaldimine A3

A round-bottomed flask was charged with 15 pbw of 1,5-diamino-2-methylpentane. With effective cooling and vigorous stirring, 40 pbw of 2,2-dimethyl-3-acetyloxypropanal were added dropwise. Following the addition the mixture was stirred at room temperature for a further 10 minutes and then all of the water was removed by distillation under a water jet vacuum. The liquid reaction product obtained in this way had an aldimine content, determined as the amine content, of 4.94 mmol NH₂/g and was used further without purification.

Polyaldimine A4

A round-bottomed flask was charged with 44 pbw of 1,3-xylylenediamine. With effective cooling and vigorous stirring, 98 pbw of 2,2-dimethyl-3-acetyloxypropanal were added dropwise. Following the addition the mixture was stirred at room temperature for a further 10 minutes and then all of the water was removed by distillation under a water jet vacuum. The liquid reaction product obtained in this way had an aldimine content, determined as the amine content, of 4.97 mmol NH₂/g and was used further without purification.

Polyaldimine A5

A round-bottomed flask was charged with 100 pbw of 4-aminomethyl-1,8-octanediamine. With effective cooling and vigorous stirring, 287 pbw of 2,2-dimethyl-3-acetyloxypropanal were added dropwise. Following the addition the mixture was stirred at room temperature for a further 10 minutes and then all of the water was removed by distillation under a water jet vacuum. The liquid reaction product obtained in this way had an aldimine content, determined as the amine content, of 4.92 mmol NH₂/g and was used further without purification.

Polyaldimine A6

A round-bottomed flask was charged with 67 pbw of Jeffamine® D-230 (Huntsman Chemicals). With effective cooling and vigorous stirring, 100 pbw of 2,2-dimethyl-3-acetyloxypropanal were added dropwise. Following the addition the mixture was stirred at room temperature for a further 10 minutes and then all of the water was removed by distillation under a water jet vacuum. The liquid reaction product obtained in this way had an aldimine content, determined as the amine content, of 3.56 mmol NH₂/g and was used further without purification.

Polyaldimine A7

A round-bottomed flask was charged with 100 pbw of Jeffamine® T-403 (Huntsman Chemicals). With effective cooling and vigorous stirring, 76 pbw of benzaldehyde were added dropwise. Following the addition the mixture was stirred at room temperature for a further 10 minutes and then all of the water was removed by distillation under a water jet vacuum. The liquid reaction product obtained in this way had an aldimine content, determined as the amine content, of 3.90 mmol NH₂/g and was used further without purification.

Prepolymer P1

530 pbw of polyol Acclaim® 4200 N and 72 pbw of 4,4′-methylenediphenyl diisocyanate (MDI; Desmodur® 44 MC L, Bayer) were reacted by a known method at 80° C. to form an NCO-terminated prepolymer. The reaction product had a titrimetrically determined free isocyanate group content of 2.00% and a viscosity at 23° C. of 28 Pa·s.

Prepolymer P2

661 pbw of polyol Caradol® ED56-11 and 139 pbw of 4,4′-methylenediphenyl diisocyanate (MDI; Desmodur® 44 MC L, Bayer) were reacted by a known method at 80° C. to form an NCO-terminated prepolymer. The reaction product had a titrimetrically determined free isocyanate group content of 2.06% and a viscosity at 23° C. of 102 Pa·s.

Prepolymer P3

1262 pbw of polyol Arcol® PPG 2000 N and 338 pbw of 4,4′-methylenediphenyl diisocyanate (MDI; Desmodur® 44 MC L, Bayer) were reacted by a known method at 80° C. to form an NCO-terminated prepolymer. The reaction product had a titrimetrically determined free isocyanate group content of 3.61% and a viscosity at 23° C. of 37 Pa·s.

Prepolymer P4

627 pbw of polyol Caradol® ED56-11 and 172 pbw of 4,4′-methylenediphenyl diisocyanate (MDI; Desmodur® 44 MC L, Bayer) were reacted by a known method at 80° C. to form an NCO-terminated prepolymer. The reaction product had a titrimetrically determined free isocyanate group content of 3.59% and a viscosity at 23° C. of 38 Pa·s.

Prepolymer P5

259 pbw of polyol Acclaim® 4200 N, 517 pbw of polyol Caradol® MD34-02 and 124 pbw of 4,4′-methylenediphenyl diisocyanate (MDI; Desmodur® 44 MC L, Bayer) were reacted by a known method at 80° C. to form an NCO-terminated prepolymer. The reaction product had a titrimetrically determined free isocyanate group content of 2.30% and a viscosity at 23° C. of 92 Pa·s.

Prepolymer P6

540 pbw of polyol Acclaim® 4200 N, 245 pbw of polyol Caradol® MD34-02 and 115 pbw of 4,4′-methylenediphenyl diisocyanate (MDI; Desmodur® 44 MC L, Bayer) were reacted by a known method at 80° C. to form an NCO-terminated prepolymer. The reaction product had a titrimetrically determined free isocyanate group content of 2.22% and a viscosity at 23° C. of 47 Pa·s.

Prepolymer P7

1462 pbw of polyol Acclaim® 4200 N and 138 pbw of tolylene diisocyanate (TDI; Desmodur® T-80 P L, Bayer; 80:20 mixture of the 2,4 and the 2,6 isomer) were reacted by a known method at 100° C. to form an NCO-terminated prepolymer. The reaction product had a titrimetrically determined free isocyanate group content of 2.12% and a viscosity at 23° C. of 11 Pa·s.

Prepolymer P8

1710 pbw of polyol Acclaim® 12200 and 91 pbw of 4,4′-methylenediphenyl diisocyanate (MDI; Desmodur® 44 MC L, Bayer) were reacted by a known method at 100° C. to form an NCO-terminated prepolymer. The reaction product had a titrimetrically determined free isocyanate group content of 0.88% and a viscosity at 23° C. of 58 Pa·s.

Prepolymer P9

221 pbw of polyol Acclaim® 4200 N, 13 pbw of tripropylene glycol and 67 pbw of 4,4′-methylenediphenyl diisocyanate (MDI; Desmodur® 44 MC L, Bayer) were reacted by a known method at 80° C. to form an NCO-terminated prepolymer. The reaction product had a titrimetrically determined free isocyanate group content of 3.70% and a viscosity at 23° C. of 38 Pa·s.

Prepolymer P10

684 pbw of polyol Acclaim® 4200 N, 15 pbw of 1,2-propanediol and 200 pbw of 4,4′-methylenediphenyl diisocyanate (MDI; Desmodur® 44 MC L, Bayer) were reacted by a known method at 80° C. to form an NCO-terminated prepolymer. The reaction product had a titrimetrically determined free isocyanate group content of 3.76% and a viscosity at 23° C. of 46 Pa·s.

Prepolymer P11

606 pbw of polyol Acclaim® 4200 N, 56 pbw of tripropylene glycol and 238 pbw of 4,4′-methylenediphenyl diisocyanate (MDI; Desmodur® 44 MC L, Bayer) were reacted by a known method at 80° C. to form an NCO-terminated prepolymer. The reaction product had a titrimetrically determined free isocyanate group content of 4.53% and a viscosity at 23° C. of 58 Pa·s.

Prepolymer P12

565 pbw of polyol Acclaim® 4200 N, 35 pbw of neopentyl glycol and 255 pbw of 4,4′-methylenediphenyl diisocyanate (MDI; Desmodur® 44 MC L, Bayer) were reacted by a known method at 80° C. to form an NCO-terminated prepolymer. The reaction product had a titrimetrically determined free isocyanate group content of 5.01% and a viscosity at 23° C. of 48 Pa·s.

Prepolymer P13

518 pbw of polyol Acclaim® 4200 N and 41 pbw of tolylene diisocyanate (TDI; Desmodur® T-80 P L, Bayer; 80:20 mixture of the 2,4 and the 2,6 isomer) were reacted by a known method at 100° C. to form an NCO-terminated prepolymer. The reaction product had a titrimetrically determined free isocyanate group content of 1.50% and a viscosity at 23° C. of 18 Pa·s.

Prepolymer P14

660 pbw of polyol Acclaim® 4200 N, 330 pbw of polyol Caradol® MD34-02 and 84 pbw of tolylene diisocyanate (TDI; Desmodur® T-80 P L, Bayer; 80:20 mixture of the 2,4 and the 2,6 isomer) were reacted by a known method at 80° C. to form an NCO-terminated prepolymer. The reaction product had a titrimetrically determined free isocyanate group content of 1.50% and a viscosity at 23° C. of 27 Pa·s.

Prepolymer P15

673 pbw of polyol Voranol® EP 1900 and 55 pbw of tolylene diisocyanate (TDI; Desmodur® T-80 P L, Bayer; 80:20 mixture of the 2,4 and the 2,6 isomer) were reacted by a known method at 80° C. to form an NCO-terminated prepolymer. The reaction product had a titrimetrically determined free isocyanate group content of 1.51% and a viscosity at 23° C. of 21 Pa·s.

### Examples 1-4 (Inventive) and Examples 5-6 (Comparative)

The prepolymers and aldimines indicated in table 1 were mixed homogeneously in an NH₂/NCO ratio (i.e., equivalents of aldimine moieties per equivalents of isocyanate groups of the prepolymer) of 0.9/1.0. The mixture was admixed with benzoic acid (350 mg/100 g of prepolymer), mixed homogeneously again and immediately dispensed to airtight tubes, which were stored at 60° C. for 15 hours. A portion of the mixture was then poured into a metal sheet coated with PTFE (film thickness: about 2 mm), cured for 7 days at 23° C. and 50% relative humidity, and subsequently the mechanical properties of the through-cured film were measured. With the remaining contents of the tube the storage stability was determined, by measurement of the viscosity before and after storage for 7 days at 60° C. The results of the tests are set out in table 1.

The results show that the inventive compositions of examples 1-4 (prepolymer based on a linear polyol with a low degree of unsaturation, cured with polyaldimine) have elasticity moduli and mechanical strengths which vary widely depending on the polyaldimine used, and also possess a very low viscosity, good storage stability and a high reactivity and cure with no bubbles. The prior art formulation of comparative example 5 (prepolymer based on a conventional linear polyol preextended with diisocyanate, cured with polyaldimine), in contrast, has a sharply increased viscosity and, when the same polyaldimine is used (ex. 5 as against ex. 4), exhibits a much lower tensile strength. The prior art formulation of comparative example 6 (prepolymer based on a linear polyol with a low degree of unsaturation, cured with atmospheric moisture) exhibits inadequate reactivity (slow skinning time) and a distinct tendency to form bubbles.

TABLE 1

| | Example | | | | | |
|---|---|---|---|---|---|---|
| | | | | | 5 | 6 |
| | 1 | 2 | 3 | 4 | comparative | comparative |
| Prepolymer | P1 | P1 | P1 | P1 | P2 | P1 |
| Polyaldimine | A1 | A2 | A3 | A4 | A4 | — |
| NCO content | 2.00 | 2.00 | 2.00 | 2.00 | 2.06 | 2.00 |
| (% by weight) | | | | | | |
| Viscosity before | 28 | 27 | 26 | 27 | 91 | 28 |
| storage (Pa · s) | | | | | | |
| Viscosity after | 32 | 33 | 29 | 32 | 96 | 31 |
| storage (Pa · s) | | | | | | |
| Skinning time | 52 | 33 | 43 | 35 | 30 | 600 |
| (min.) | | | | | | |
| Bubble formation | none | none | none | none | none | many |
| Tensile strength | 4.2 | 8.3 | 8.8 | 12.1 | 4.9 | n.m. |
| (MPa) | | | | | | |
| Breaking | 1000 | 1300 | 1300 | 1300 | 1400 | n.m. |
| elongation (%) | | | | | | |
| Elasticity modulus | 1.6 | 1.9 | 2.0 | 13.1 | 15.6 | n.m. |
| 0.5-5% (MPa) | | | | | | |

(n.m. = not measurable)

### Example 7 (Inventive) and Example 8 (Comparative)

In the same way as described in example 1 compositions were prepared from various prepolymers and aldimines and tested. The prepolymers and aldimines used and also the results of the tests are set out in table 2.

The results show that the inventive composition of example 7 (linear polyol with low degree of unsaturation) has much higher tensile strength than the prior art formulation of comparative example 8 (conventional linear polyol), and achieves this with properties which are otherwise comparable.

TABLE 2

Example

| | 7 | 8 (comparative) |
|---|---|---|
| Prepolymer | P3 | P4 |
| Polyaldimine | A4 | A4 |
| NCO content (% by weight) | 3.61 | 3.59 |
| Viscosity before storage (Pa · s) | 37 | 34 |
| Viscosity after storage (Pa · s) | 38 | 35 |
| Skinning time (min.) | 32 | 30 |
| Bubble formation | none | none |
| Tensile strength (MPa) | 11.3 | 7.2 |
| Breaking elongation (%) | 710 | 700 |
| Elasticity modulus 0.5-5% (MPa) | 26.6 | 28.8 |

### Examples 9, 12-14 (Inventive) and Examples 10, 11, 15, 16 (Comparative)

In the same way as described in example 1 compositions were prepared from various prepolymers and aldimines and tested. The prepolymers and aldimines used and also the results of the tests are set out in table 3.

The results show that the inventive compositions of examples 9 and 12-14 (prepolymer based on a linear polyol with a low degree of unsaturation, cured with polyaldimine mixture having a total functionality >2) have lower viscosities than the prior art formulations of comparative examples 10 and 15 (prepolymer with total functionality >2 based on a mixture of linear and nonlinear polyol, cured with polyaldimine having a total functionality of 2) (ex. 10 in comparison to ex. 9 and ex. 15 in comparison to ex. 14). The prior art formulations of comparative examples 11 and 16 (prepolymer with total functionality >2 based on a mixture of linear and nonlinear polyol, cured with atmospheric moisture) have inadequate reactivity in comparison to the other examples (slow skinning time) and also have a tendency to form bubbles.

TABLE 3

| | Example | | | | | | | |
|---|---|---|---|---|---|---|---|---|
| | | 10 | 11 | | | | 15 | 16 |
| | 9 | comparative | comparative | 12 | 13 | 14 | comparative | comparative |
| Prepolymer | P1 | P5 | P5 | P1 | P1 | P1 | P6 | P6 |
| Polyaldimine(s), | A2/A5, | A2 | — | A2/A5, | A6/A5, | A4/A5, | A2 | — |
| ratio (pbw/pbw) | 2/1 | | | 7/1 | 7/1 | 7/1 | | |
| Total functionality | 2.0 | 2.3 | 2.3 | 2.0 | 2.0 | 2.0 | 2.1 | 2.1 |
| prepolymer | | | | | | | | |
| Total functionality | 2.3 | 2.0 | (2.0) | 2.1 | 2.1 | 2.1 | 2.0 | (2.0) |
| polyaldimines | | | | | | | | |
| NCO content (% by | 2.00 | 2.30 | 2.30 | 2.00 | 2.00 | 2.00 | 2.22 | 2.22 |
| weight) | | | | | | | | |
| Viscosity before | 30 | 87 | 92 | 28 | 25 | 28 | 48 | 49 |
| storage (Pa · s) | | | | | | | | |
| Viscosity after | 38 | 108 | 105 | 35 | 29 | 32 | 63 | 58 |
| storage (Pa · s) | | | | | | | | |
| Skinning time | 24 | 12 | 240 | 23 | 20 | 23 | 15 | 320 |
| (min.) | | | | | | | | |
| Bubble formation | none | none | some | none | none | none | none | many |
| Tensile strength | 2.3 | 2.6 | 2.3 | 4.1 | 2.8 | 5.0 | 3.7 | n.m. |
| (MPa) | | | | | | | | |
| Breaking elongation | 270 | 230 | 190 | 620 | 640 | 450 | 400 | n.m. |
| (%) | | | | | | | | |
| Elasticity modulus | 2.4 | 3.0 | 5.2 | 2.0 | 1.4 | 9.4 | 3.0 | n.m. |
| 0.5-5% (MPa) | | | | | | | | |

(n.m. = not measurable)

### Example 17 (Inventive) and Example 18 (Comparative)

In the same way as described in example 1 compositions were prepared from various prepolymers and aldimines and tested. The prepolymers and aldimines used and also the results of the tests are set out in table 4.

The results show that the inventive composition of example 17 (prepolymer based on a linear polyol having a low degree of unsaturation, cured with polyaldimine) has a very low viscosity, good mechanical properties and a high reactivity (rapid skinning time) and cures without bubbles. In contrast the prior art formulation of comparative example 18 (prepolymer based on a linear polyol having a low degree of unsaturation, cured with atmospheric moisture) exhibits inadequate reactivity and a tendency to form bubbles.

TABLE 4

Example

| | 17 | 18 comparative |
|---|---|---|
| Prepolymer | P7 | P7 |
| Polyaldimine | A4 | — |
| NCO content (% by weight) | 2.12 | 2.12 |
| Viscosity before storage (Pa · s) | 11 | 11 |
| Viscosity after storage (Pa · s) | 12 | 12 |
| Skinning time (min.) | 37 | >600 |
| Bubble formation | none | some |
| Tensile strength (MPa) | 10.2 | remains tacky, |
| Breaking elongation (%) | 1300 | soft; |
| Elasticity modulus 0.5-5% (MPa) | 10.3 | n.m. |

(n.m. = not measurable)

### Examples 19-20 (Inventive) and Example 21 (Comparative)

In the same way as described in example 1 compositions were prepared from various prepolymers and aldimines and tested. The prepolymers and aldimines used and also the results of the tests are set out in table 5.

The results show that the inventive compositions of examples 19 and 20 (prepolymer based on a long-chain linear polyol with a low degree of unsaturation, cured with polyaldimine mixture with a total functionality of 2 or >2, respectively) have good mechanical properties, a high reactivity (short skinning time) and exhibit bubble-free curing. Example 20, with a polyaldimine mixture of total functionality >2, exhibits a higher tensile strength as compared with example 19. The prior art formulation of comparative example 21 (prepolymer based on a long-chain linear polyol with a low degree of unsaturation, cured with atmospheric moisture) exhibits inadequate reactivity and a tendency to form bubbles as compared with the inventive examples 19 and 20. The storage stability of the three examples is good in each case (low increase in viscosity during storage).

TABLE 5

| | Example | | |
|---|---|---|---|
| | | | 21 |
| | 19 | 20 | comparative |
| Prepolymer | P8 | P8 | P8 |
| Polyaldimine(s), ratio | A4 | A4/A5, | — |
| (pbw/pbw) | | 7/1 | |
| NCO content (% by weight) | 0.88 | 0.88 | 0.88 |
| Viscosity before storage (Pa · s) | 58 | 66 | 60 |
| Viscosity after storage (Pa · s) | 72 | 82 | 70 |
| Skinning time (min.) | 52 | 48 | >600 |
| Bubble formation | none | none | some |
| Tensile strength (MPa) | 4.2 | 4.7 | remains soft, |
| Breaking elongation (%) | >1300 | 1040 | pasty; |
| Elasticity modulus 0.5-5% (MPa) | 2.9 | 2.4 | n.m. |

(n.m. = not measurable)

TABLE 6

| | Example | | | | | | | | | |
|---|---|---|---|---|---|---|---|---|---|---|
| | | | | 25 | | 27 | | 29 | | 31 |
| | 22 | 23 | 24 | comparative | 26 | comparative | 28 | comparative | 30 | comparative |
| Prepolymer | P9 | P9 | P9 | P9 | P10 | P10 | P11 | P11 | P12 | P12 |
| Polyaldimine(s), | A2 | A3 | A4 | — | A2/A5, | — | A2/A5, | — | A2/A5, | — |
| ratio (pbw/pbw) | | | | | 7/1 | | 7/1 | | 3/1 | |
| NCO content | 3.70 | 3.70 | 3.70 | 3.70 | 3.76 | 3.76 | 4.53 | 4.53 | 5.01 | 5.01 |
| (% by weight) | | | | | | | | | | |
| Viscosity before | 36 | 35 | 36 | 38 | 43 | 46 | 56 | 58 | 46 | 48 |
| storage (Pa · s) | | | | | | | | | | |
| Viscosity after | 43 | 37 | 40 | 43 | 50 | 51 | 65 | 64 | 55 | 52 |
| storage (Pa · s) | | | | | | | | | | |
| Skinning time | 41 | 51 | 42 | 360 | 45 | 420 | 42 | 360 | 41 | 480 |
| (min.) | | | | | | | | | | |
| Bubble formation | none | none | none | very | none | very | none | very | none | very |
| | | | | many | | many | | many | | many |
| Tensile strength | 15.0 | 14.5 | 17.0 | n.m. | 14.1 | n.m. | 15.6 | n.m. | 18.4 | n.m. |
| (MPa) | | | | | | | | | | |
| Breaking | 790 | 770 | 810 | n.m. | 500 | n.m. | 600 | n.m. | 330 | n.m. |
| elongation (%) | | | | | | | | | | |
| Elasticity | 5.8 | 4.1 | 33.1 | n.m. | 5.3 | n.m. | 10.5 | n.m. | 40.0 | n.m. |
| modulus 0.5-5% | | | | | | | | | | |
| (MPa) | | | | | | | | | | |

(n.m. = not measurable)

### Examples 22-24, 26, 28, 30 (Inventive) and Examples 25, 27, 29, 31 (Comparative)

In the same way as described in example 1 compositions were prepared from various prepolymers and aldimines and tested. The prepolymers used, differing in isocyanate content, and the aldimines and also the results of the tests are set out in table 6.

The results show that the inventive compositions of examples 22-24 and 26, 28 and 30 (prepolymers based on a linear polyol with a low degree of unsaturation and a low molecular weight diol, cured with a polyaldimine or with a polyaldimine mixture with a total functionality of 2 or >2, respectively) have very good mechanical properties, which can be altered by varying the polyaldimine. The corresponding prepolymers were cured in the prior art formulations of comparative examples 25, 27, 29 and 31 using atmospheric moisture. The comparative examples exhibit a very much lower reactivity (long skinning time) and a strong tendency to form bubbles. The mechanical values for these examples cannot be sensibly measured, in view of the many bubbles.

### Example 32

### (Sealant)(Inventive)

In a vacuum mixer 30 pbw of prepolymer P13, 25 pbw of chalk powder Omyacarb® 5 GU (Omya), 20 pbw of plasticizer Palatinol® Z (diisodecyl phthalate, BASF), 10 pbw of PVC powder Solvic® 373 MC (Solvay), 10 pbw of thickener Crayvallac® super (Cray Valley), 3 pbw of xylene, 0.2 pbw of stabilizer Irganox® 1010 (Ciba), 0.2 pbw of silane Silquest® A-187 (OSi Crompton), 0.1 pbw of benzoic acid, 1.1 pbw of polyaldimine A1 and 1.6 pbw of polyaldimine A7 were processed to a lump-free, homogeneous paste which was dispensed into airtight cartridges.

The results of the tests performed thereon are set out in table 7.

### Example 33

### (Sealant)(Comparative)

In a vacuum mixer 30 pbw of prepolymer P14, 25 pbw of chalk powder Omyacarb® 5 GU (Omya), 20 pbw of plasticizer Palatinol® Z (diisodecyl phthalate, BASF), 10 pbw PVC powder Solvic® 373 MC (Solvay), 10 pbw of thickener Crayvallac® super (Cray Valley), 3 pbw of xylene, 0.2 pbw of stabilizer Irganox® 1010 (Ciba), 0.2 pbw of silane Silquest® A-187 (OSi Crompton), 0.1 pbw of benzoic acid and 2.2 pbw of polyaldimine A1 were processed to a lump-free, homogeneous paste which was dispensed into airtight cartridges.

The results of the tests performed thereon are set out in table 7.

The inventive sealant of example 32 (prepolymer based on a linear polyol with a low degree of unsaturation, partially cured with polyaldimine mixture having a total functionality >2), in comparison with the prior-art-formulated sealant of comparative example 33 (prepolymer with total functionality >2 based on a mixture of linear and nonlinear polyol, partially cured with polyaldimine having a total functionality of 2), has a lower expression force and a shorter string rupture, owing to the lower viscosity of the prepolymer, in combination with a dry surface quality and otherwise similar values for the mechanical properties, the reactivity and the storage stability.

### Example 34

### (Sealant)(Comparative)

In a vacuum mixer 30 pbw of prepolymer P15, 25 pbw of chalk powder Omyacarb® 5 GU (Omya), 20 pbw of plasticizer Palatinol® Z (diisodecyl phthalate, BASF), 10 pbw of PVC powder Solvic® 373 MC (Solvay), 10 pbw of thickener Crayvallac® super (Cray Valley), 3 pbw of xylene, 0.2 pbw of stabilizer Irganox® 1010 (Ciba), 0.2 pbw of silane Silquest® A-187 (OSi Crompton), 0.1 pbw of benzoic acid, 1.1 pbw of polyaldimine A1 and 1.6 pbw of polyaldimine A7 were processed to a lump-free, homogeneous paste which was dispensed into airtight cartridges.

The results of the tests performed thereon are set out in table 7.

The inventive sealant of example 32 (prepolymer based on a linear polyol with a low degree of unsaturation, partially cured with polyaldimine mixture having a total functionality >2), in comparison with the prior-art-formulated sealant of comparative example 34 (prepolymer based on a conventional linear polyol, partially cured with polyaldimine mixture having a total functionality of >2), has distinctly better mechanical properties and a dry surface quality.

TABLE 7

| | Example | | |
|---|---|---|---|
| | | 33 | 34 |
| | 32 | comparative | comparative |
| Surface quality after curing | dry | dry | tacky |
| Skinning time (min.) | 250 | 90 | 135 |
| Volume curing rate (mm/day) | 1.8 | 2.4 | 2.5 |
| Shore A hardness | 47 | 44 | 18 |
| String rupture (mm) | 28 | 40 | 15 |
| Expression force (N) | 443 | 558 | 271 |
| Storage stability | OK | OK | OK |
| Tensile strength (MPa) | 2.2 | 3.0 | 0.3 |
| Breaking elongation (%) | 880 | 1080 | 250 |
| Stress at 100% elongation (MPa) | 0.98 | 0.81 | 0.18 |

1. A composition comprising:
at least one polyurethane prepolymer A having isocyanate end groups, prepared from at least one polyisocyanate with at least one polyol A1 and optionally at least one polyol A2, as specified below:
A1: linear polyoxyalkylene polyol having a degree of unsaturation <0.04 meq/g;
A2: polyol in an amount of 0-30% by weight, based on the total amount of A1+A2; and
at least one polyaldimine B.

2. The composition according to claim 1, wherein the polyol A1 has a molecular weight of 2000-30 000 g/mol.

3. The composition according to claim 1, wherein the degree of unsaturation of the polyol A1 is <0.02 meq/g.

4. The composition according to claim 1, wherein the polyol A1 is a polyol prepared by means of DMC catalysis.

5. The composition according to claim 1, wherein the polyol A1 is a polyoxypropylene diol or an ethylene oxide-endcapped polyoxypropylene diol.

6. The composition according to claim 1, wherein the polyol A2 is a polyoxyalkylene polyol having a degree of unsaturation >0.04 meq/mol.

7. The composition according to claim 1, wherein the polyol A2 is a polyoxyalkylene polyol having a molecular weight of 400-2000 g/mol.

8. The composition according to claim 1, wherein the polyol A2 is a polyoxyalkylene polyol having an OH functionality of greater than 2 and up to about 3.

9. The composition according to claim 1, wherein the polyol A2 is selected from the group consisting of 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, hydrogenated bisphenol A, 1,1,1-trimethylolethane, 1,1,1-trimethylolpropane and glycerol.

10. The composition according to claim 1, wherein the polyisocyanate is a diisocyanate.

11. The composition according to claim 1, wherein the aldehyde on which the polyaldimine B is based does not have a C—H moiety positioned a to the carbonyl group.

12. The composition according to claim 1, wherein the polyurethane prepolymer A and the polyaldimine B is present in a ratio of 0.1-1.1 equivalent of aldimine moieties per equivalent of isocyanate groups.

13. A process for preparing the composition according to claim 1, comprising preparing a polyaldimine by reacting an aldehyde with an amine in a manner known per se.

14. An adhesive comprising the composition according to claim 1.

15. An arrangement comprising the composition according to claim 1.

16. An article having a surface that has been at least partly contacted with a composition according to claim 1.

17. A process for bonding, comprising contacting with a composition according to claim 1.

18. A process for sealing, comprising contacting with a composition according to claim 1.

19. A process for coating, comprising contacting with a composition according to claim 1.

20. The process according to claim 17, further comprising curing in the air.

21. The process according to claim 17, further comprising contacting with a hydrous component or an admixture thereof.

22. The composition according to claim 1, wherein A2 is present in an amount of 0-20% by weight, based on the total amount of A1+A2.

23. The composition according to claim 1, wherein A2 is present in an amount of 0-10% by weight, based on the total amount of A1+A2.

24. The composition according to claim 1, wherein the polyol A1 has a molecular weight of 2000-20 000 g/mol.

25. The composition according to claim 1, wherein the degree of unsaturation of the polyol A1 is <0.017 meq/g.

26. A sealant comprising the composition according to claim 1.

27. A coating comprising the composition according to claim 1.

28. A covering comprising the composition according to claim 1.
